(19) United States
(12) Patent Application Publication
(10) Pub. No.: US 2009/0077518 A1
(43) Pub. Date: Mar. 19, 2009

(54) DERIVED LEVEL RECOGNITION IN A LAYOUT EDITOR

(75) Inventors: Mark R. Beckenbaugh, Rochester, MN (US); Michael D. Cesky, Rochester, MN (US); Jay A. Lawrence, Rochester, MN (US); Lily L. Wang, Rochester, MN (US); Nicholas G. Young, Rochester, MN (US); John W. Zack, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/856,819

(22) Filed: Sep. 18, 2007

(51) Int. Cl. G06F 17/50

(52) U.S. Cl. 716/11

(57) ABSTRACT

A computer program product stored on machine readable media includes machine executable instructions for displaying a layout of a circuit design, the product including instructions for: over a plurality of layers within a design, identifying at least one of a derived level and a device defined within the plurality; and displaying the at least one derived level and device to a user.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to design layout editors, and particularly to features for layout and level checking in circuit design.

2. Description of the Related Art

An important step in the chip build process is to create a layout design. From this layout design, several masks are created to correctly map out the location of each level on the chip. A layout design includes many layers that are actually mapped out and several more layers which can be created from a combination of multiple layers interacting with each other.

It is essential for the layout designer to understand how all of the levels interact with each other and what will be created as a result of those interactions. In order to help with this process several checking decks are used. These checking decks are coded to correctly identify the resulting effect of combining several layers. However, present techniques for checking decks require execution of many manual steps.

What is needed is an ability to recognize and display derived levels and devices, that result from multiple design layers interacting with each other, where the ability is incorporated into a layout editor. Preferably, this function may be toggled on and off as needed.

### SUMMARY OF THE INVENTION

In one embodiment, a computer program product stored on machine readable media includes machine executable instructions for displaying a layout of a circuit design, the product including instructions for: over a plurality of layers within a design, identifying at least one of a derived level and a device defined within the plurality; and displaying the at least one derived level and device to a user.

In another embodiment, a computer program product stored on machine readable media is disclosed and includes machine executable instructions for displaying a layout of a circuit design, the product including instructions for: receiving input from a user for generating a circuit design in a plurality of layers; storing design information for each one of a derived level and a device of the design in a truth table; for each truth table, identifying at least one of an associated derived level and an associated device, wherein the identifying comprises recognizing the at least one derived level and device according to design conditions for the respective one of the derived level and device; and displaying the at least one derived level and device to a user.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a user is provided with an editor having a feature for recognizing and displaying derived levels and devices that result from multiple layers interacting with each other in the layout editor. The feature may generally be toggled on and off as needed.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of an infrastructure for operation of a layout editor;

FIG. 2 illustrates a prior art display of a layout with diffusions manually identified by additional text;

FIG. 3 is an exemplary illustration of a display that includes independent identification characteristics;

FIG. 4 provides an example of a prior art display of a layout where diffusions are not accurately identified;

FIG. 5 illustrates one example of a display addressing the problems of FIG. 4; and

FIG. 6 provides an exemplary method for level recognition.

The detailed description explains the preferred embodiments of the invention, together with advantages and features, by way of example with reference to the drawings.

### DETAILED DESCRIPTION OF THE INVENTION

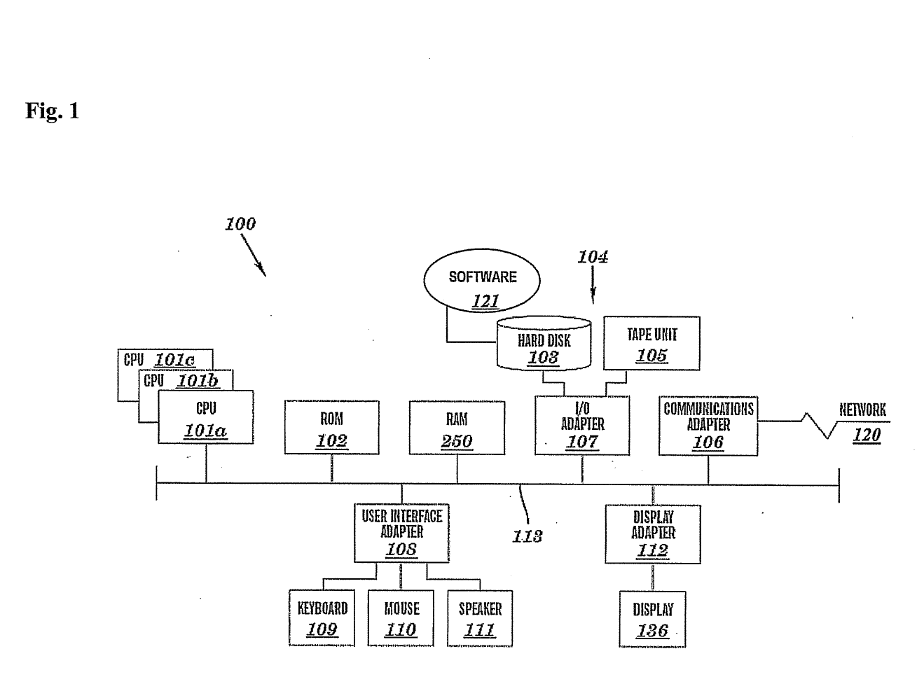

Referring to FIG. 1, there is shown an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for layout and editing of a circuit design. As referred to herein, a “design layout software” 121 provides an environment for a derived level recognition feature. The software 121 (and the feature) may be produced using software development tools as are known in the art. As discussed herein, the software 121 may also be referred to as a “layout editor” 121 or simply as an “editor” 121. The layout editor 121 may include various other editing tools and layout features as are known in the art.

The feature may be included as a part of the editor 121 (that is, as an integrated feature), or provided as supplemental program code (that is, as an “add-in” feature for addition to an installed editor 121). Accordingly, one will recognize that certain aspects of the editor 121 and the feature may not belong exclusively to one or the other aspect.

In general, the layout editor 121 permits a designer to focus on a particular aspect of a circuit layout, or a layout of a similar nature. As used herein, these aspects are generally referred to as “coordinates” within a layout. Coordinates may be identified according to various conventions, such as by screen area, layout area, workspace area, with relation to a given point of origin and by other such schemes as are known in the art.

The teachings herein provide the editor 121 with a feature for recognizing and displaying derived levels and devices that result from multiple layers interacting with each other. The feature may generally be toggled on and off as needed. Prior to discussing particular aspects of the feature, some additional perspective is provided.

Two of the most important tools used for checking are commonly referred to as “Design Rule Checks (DRC)” and “Layout vs. Schematic checks (LVS).” DRC checking decks are generally used to verify that design requirements, known as design rules, are not violated. LVS checks are generally used to ensure the correct levels were used to make the desired devices, such as a field effect transistor (e.g., an NFET or PFET), and to ensure the resulting devices are then properly connected as defined in the schematic.

Design Rule Abbreviations are often used to simplify the extensive set of design rules. The purpose of the abbreviations is to remove clutter from the process of identifying and labeling the result of the several layers interacting with each other. In this manner, one may check against the resulting level instead of the other layers that may have created it. In Table 1 below is an example of a set of Design Rule Abbreviations.

TABLE 1
Design Rule Abbreviations

| | |
|---|---|
| Gate | PC over RX |
| NFET gate | Gate not over BP |
| PFET gate | Gate over BP |
| RX butted n−well contact | (RX n−well contact) coinciding with |
| | (RX over BP) |
| RX butted p−well contact | (RX p−well contact) coinciding with |
| | (RX not over BP) |
| RX n+diffusion | RX n+ junction not over PC |
| RX n+junction | RX not over [BP or (NW not over N3)] |
| RX n−well contact | (RX not over BP) over (NW not over N3) |
| RX p+diffusion | RX p+junction not over PC |
| RX p+junction | (RX over BP) over (NW not over N3) |

The foregoing provides a workable solution for the checking decks. However, one problem is that it is up to the person working with the layout to correctly identify the resulting design levels as identified in the Design Rule Abbreviations. For example, in order for a layout designer to identify “RX p+ diffusion”, they must first identify a “RX p+ junction”, which may be defined as (RX over BP) over (NW not over N3). It should be noted that the examples and definitions used herein are technology specific and provided for illustrative purposes only.

In addition to the Design Rule Abbreviations, Design Truth Tables are also used. The Design Truth Tables provide for identifying levels needed to create a device. It is also up to the designer to identify the device by examining the layers used to create it. Table 2 below is one example of a portion of a Design Truth Table.

TABLE 2
Design Truth Table

| | Design Levels | | | | | | | | | | | |
|---|---|---|---|---|---|---|---|---|---|---|---|---|
| Structure | RX | NW | N3 | T3 | LVT | RVT | HVT | ZVT | PC | EG | DG | TG |
| Low-Vt NFET | 1 | 0 | 0 | 0 | 1 | 0 | 0 | 0 | 1 | 0 | 0 | 0 |
| Low-Vt PFET | 1 | 1 | 0 | 0 | 1 | 0 | 0 | 0 | 1 | 0 | 0 | 0 |
| Regular-Vt NFET | 1 | 0 | 0 | 0 | 0 | 1 | 0 | 0 | 1 | 0 | 0 | 0 |
| Regular-Vt PFET | 1 | 1 | 0 | 0 | 0 | 1 | 0 | 0 | 1 | 0 | 0 | 0 |
| High-Vt NFET | 1 | 0 | 0 | 0 | 0 | 0 | 1 | 0 | 1 | 0 | 0 | 0 |
| High-Vt PFET | 1 | 1 | 0 | 0 | 0 | 0 | 1 | 0 | 1 | 0 | 0 | 0 |

The truth table provided in Table 2 is provided as a physical design aid for the listed structures. That is, a truth table may be established to provide design conditions for each of the derived levels and devices. Values in the truth tables are defined as: “0” indicates that the design or derived level must not touch the structure; “1” indicates that the design or derived level must cover or match the structure; “x” indicates that the design level does not affect the structure or the derived level might not be present depending on the design levels.

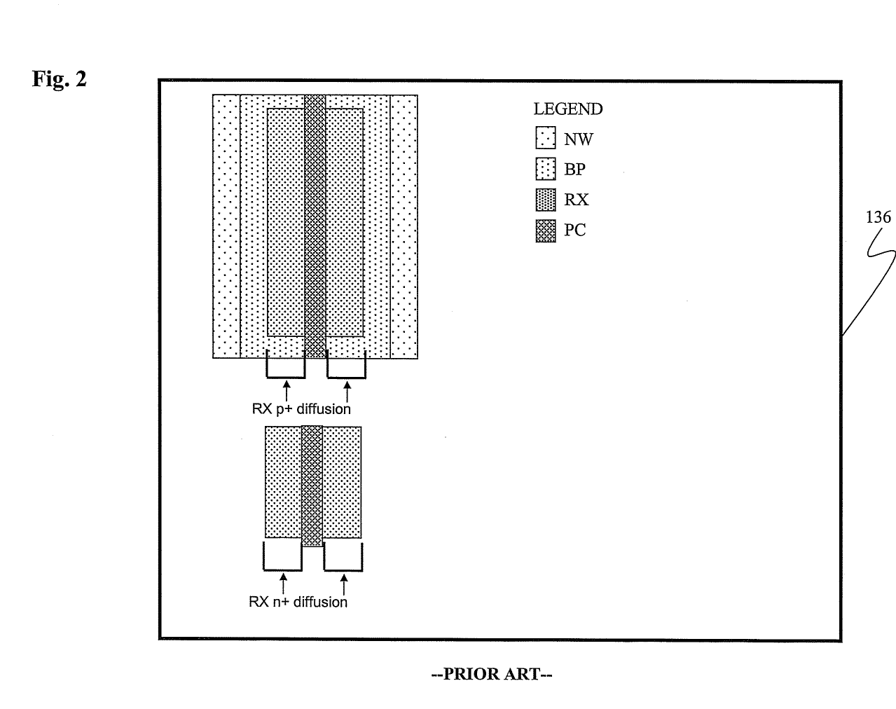

Using the definitions for RX p+ diffusion and RX n+ diffusion as defined above in Table 1, a typical prior art layout could be displayed as shown in FIG. 2. In the illustration of FIG. 2, the original layout is shown on the display 136 with diffusions manually identified.

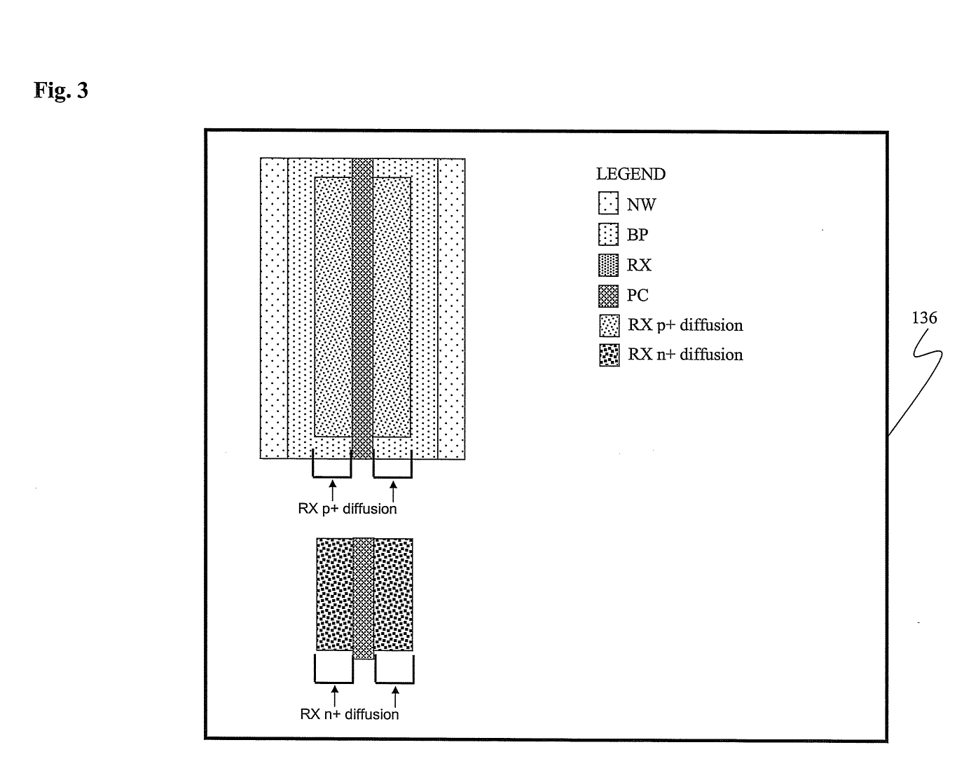

Now with reference to FIG. 3, an illustration is provided where the derived levels are recognized and displayed as a new derived level with independent identification characteristics. In some embodiments, the feature of the editor 121 further enables layout designers to identify derived levels without having to view all of the levels required to compromise the resulting level.

The feature makes use of an algorithm, or set of algorithms, for identifying at least one of the derived levels and devices. That is, the feature includes a device recognition algorithm that may include a set of instructions for providing visual indications in the display 136. The indications are located and provided according to design rule data and truth table data that are correlated to elements of each layout (for example, a circuit component such as a an NFET or PFET).

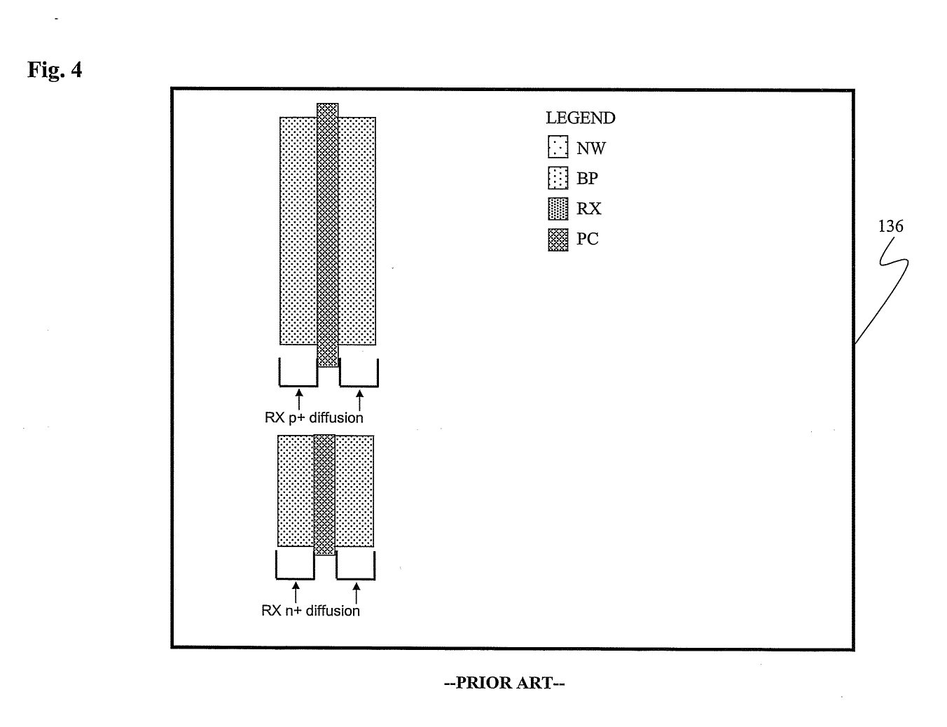

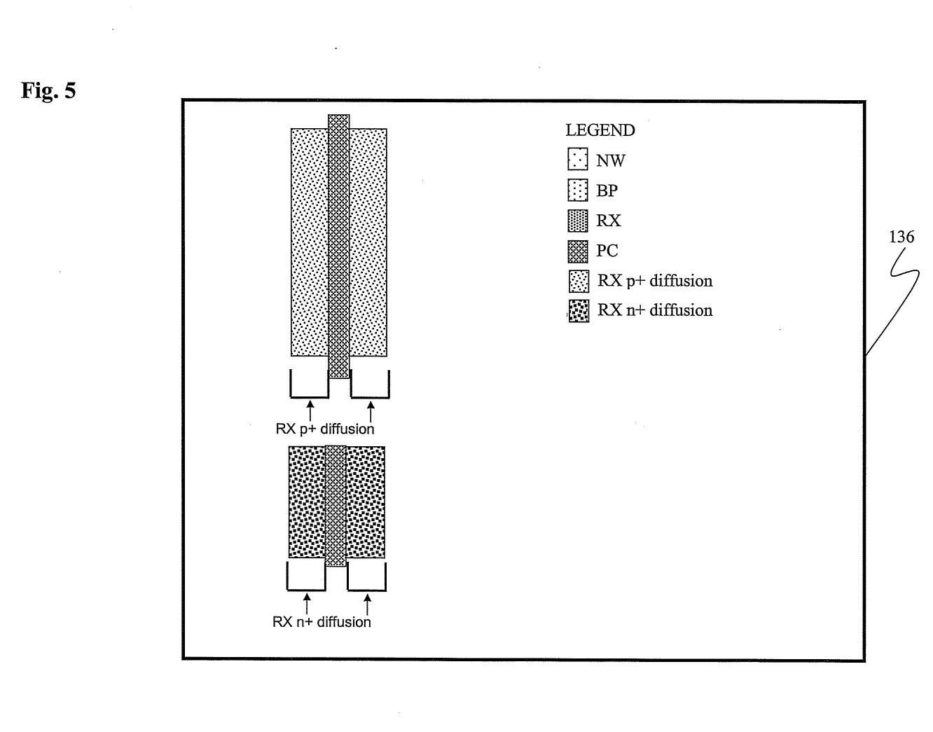

Now with reference again to the prior art, in FIG. 4, bias of the diffusions can not be accurately identified as all of the appropriate levels are not displayed. The same situation is depicted in FIG. 5, where the feature provides for an enhanced view. In FIG. 5, the RX p+ diffusion and RX n+ diffusion are easily identified without a requirement for showing of all of the levels needed for defining the resulting levels.

It should be noted that the examples used here are relatively simple in nature. The value of this feature becomes even more apparent as more complex devices and levels are derived from numerous levels. If desired, some up to all derived structures from the truth tables could be displayed uniquely in this fashion.

Accordingly, the feature of the editor 121 is provided as instructions for displaying the results of a device recognition algorithm in a manner which identifies structures that are commonly designed for circuits. The basis for determining which structures are highlighted are defined in a set of rules which can be read from pre-existing rules or designed using an interactive menu. The user has the option of changing level display options similar to currently implemented display options for layer functions.

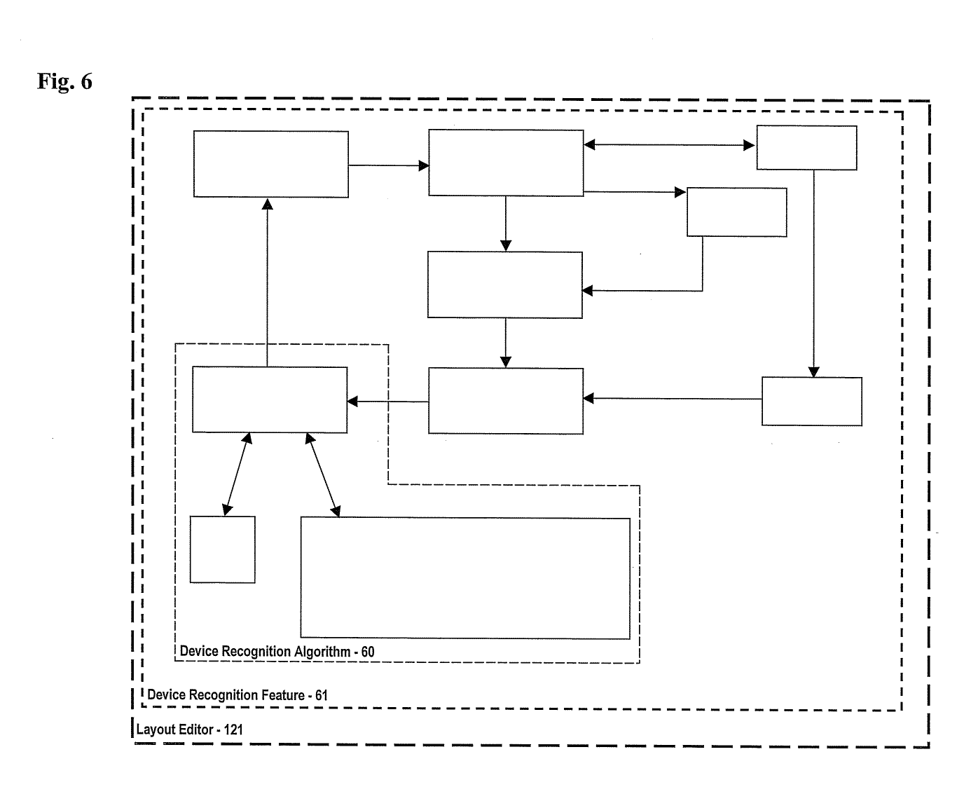

The flow diagram of FIG. 6 illustrates an exemplary process and method of the derived level recognition feature 61 of the editor 121 including a device recognition algorithm 60. In addition, the editor 121 may include other features that will setup and regulate each of the algorithms represented in FIG. 6. In some embodiments, device recognition can be extended to any perceived combination of shapes or structures and does not have to be limited to what is commonly referred to as a “device” in integrated circuits.

As shown in FIG. 6, the device recognition algorithm 61 may include a variety of components, each one providing certain functionality. It should be recognized that some of the components may be included in the device recognition algorithm 61 as a part of the editor 121. Accordingly, the device recognition algorithm 60 and the device recognition feature 61 of FIG. 6 are merely illustrative and are not limiting of the teachings herein.

Components of the device recognition feature 61 may include, for example, a shapes editor, an initiator and setup routine, a proximity search engine, a window function, an interface with the editor 121, a shape change stack and others. The device recognition algorithm 60, also a part of the device recognition feature 61, may include device recognition components such as a rules editor and a storage including a source of device rules.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine executable instructions for displaying a layout of a circuit design, the product comprising instructions for:
over a plurality of layers within a design, identifying at least one of a derived level and a device defined within the plurality; and
displaying the at least one derived level and device to a user.

2. The computer program product as in claim 1, wherein the identifying comprises recognizing the at least one derived level and device according to a plurality of design rules.

3. The computer program product as in claim 1, wherein the identifying comprises recognizing the at least one derived level and device according to design conditions for the respective one of the derived level and device.

4. The computer program product as in claim 1, wherein the instructions are provided as supplemental program code for incorporation into a layout editor.

5. The computer program product as in claim 1, further comprising instructions for adjusting the displaying.

6. A computer program product stored on machine readable media and comprising machine executable instructions for displaying a layout of a circuit design, the product comprising instructions for:
receiving input from a user for generating a circuit design in a plurality of layers;
storing design information for each one of a derived level and a device of the design in a truth table;
for each truth table, identifying at least one of an associated derived level and an associated device, wherein the identifying comprises recognizing the at least one derived level and device according to design conditions for the respective one of the derived level and device; and
displaying the at least one derived level and device to a user.
